(19) United States
(12) Patent Application Publication
(10) Pub. No.: US 2011/0015554 A1
(43) Pub. Date: Jan. 20, 2011

(54) MASSAGE APPARATUS

(75) Inventors: Daisuke Morikawa, Osaka (JP); Keisuke Shimizu, Osaka (JP)

Correspondence Address: WOLF GREENFIELD & SACKS, P.C., 600 ATLANTIC AVENUE, BOSTON, MA, 02210-2206, US

(73) Assignee: Panasonic Electric Works Co., LTD, Osaka (JP)

(21) Appl. No.: 12/933,962

(22) PCT Filed: Mar. 9, 2009
(86) PCT No.: PCT/JP2009/054448

§ 371 Date: Sep. 22, 2010

(30) Foreign Application Priority Data
Mar. 26, 2008 (JP) 2008-080340
Jan. 29, 2009 (JP) 2009-018026

(51) Int. Cl. A61H 7/00

(52) U.S. Cl. 601/84

(57) ABSTRACT

A massage apparatus (10) capable of improving a sensation of stretching around a pelvic bone performs stretching around the pelvic bone of a user by arching, twisting (pivoting and bending to the side), and bending forward and back as airbags (20a, 20b) provided to a back rest (13) and airbags (21a, 21b) provided to a seat (12) operate together with a mutual time difference.

### TECHNICAL FIELD

The present invention relates to a chair type massage machine that is optimal for stretching the pelvic portion of the human body.

### BACKGROUND ART

Examples of prior art chair type massage machines are described in patent documents 1 to 4. A massage machine of the prior art has a backrest that includes left and right airbags (lifting mechanisms). The left and right airbags are separately controlled when inflated and deflated so that they mainly twist the user's hip, back, and the like.

[Patent Document 1] Japanese Laid-Open Patent Publication No. 2000-51300

[Patent Document 2] Japanese Laid-Open Patent Publication No. 2003-250851

[Patent Document 3] Japanese Laid-Open Patent Publication No. 2005-152384

[Patent Document 4] Japanese Laid-Open Patent Publication No. 2005-328942

### DISCLOSURE OF THE INVENTION

A massage machine that separately inflates and deflates the left and right airbags in the backrest, as in patent documents 1 to 4, cannot sufficiently satisfy the desire for stretching mainly the pelvis and surrounding area in the human body. The pelvis of a user seated on a chair is supported by both of the backrest and seat. However, the user would not feel as if the pelvis has been sufficiently twisted and stretched just with the airbags in the backrest. It may also be considered that the user would not feel a sufficient stretching sensation around the pelvis other than twisting.

It is an object of the present invention to provide a massage machine that improves the stretching sensation around the pelvis.

To achieve the above object, a first aspect is a chair-type massage machine including a backrest, a seat, and at least two lifting mechanisms from among a hip lifting mechanism, which is arranged on the backrest and includes a left portion and right portion, a buttock lifting mechanism, which is arranged on the seat and includes a left portion and a right portion, and a front buttock lifting mechanism, which is arranged on a front part of the seat and extends in a widthwise direction. A control means for controlling the at least two lifting mechanisms operates the at least two lifting mechanisms in cooperation with one another with a time lag in between to perform stretching on a user.

In the first aspect, the hip lifting mechanism acts in the upper portion of the pelvis, the buttock lifting mechanism acts on the lower portion of the pelvis, and the front buttock lifting mechanism prevents forward displacement of the user's buttocks (pelvis). Two of the lifting mechanisms cooperate with a time lag in between to improve the stretching sensation of the pelvis and surrounding area.

In a second aspect, the at least two lifting mechanisms include the hip lifting mechanism and the buttock lifting mechanism, and the hip lifting mechanism and the buttock lifting mechanism perform the stretching by carrying out a twisting operation on a pelvis of the user that combines a right twisting operation in which one of the right portions of the hip lifting mechanism and the buttock lifting mechanism performs a lifting operation and, after a predetermined time, the other one of the right portions performs a lifting operation, and a left twisting operation in which one of the left portions of the hip lifting mechanism and the buttock lifting mechanism performs a lifting operation and, after a predetermined time, the other one of the left portions performs a lifting operation.

In the second aspect, the twisting operation is performed in a stepped manner on the pelvis. This improves the stretching sensation.

In a third aspect, each of the lifting mechanisms is formed by an airbag that is inflated and deflated.

In the third aspect, the lifting mechanism formed by an airbag that is inflated and deflated allows for improvement of the stretching sensation of the pelvis and surrounding area. Further, by using the airbag, the structure is relatively simple, and the lifting operation is smoothly performed.

In a fourth aspect, the at least two lifting mechanisms include the hip lifting mechanism and the buttock lifting mechanism, and the hip lifting mechanism and the buttock lifting mechanism perform the stretching by carrying out a twisting operation on a pelvis of the user that combines a right twisting operation in which the left portion and the right portion of the hip lifting mechanism perform a lifting operation while, after a predetermined time, the right portion of the buttock lifting mechanism performs a lifting operation, and a left twisting operation in which the left portion of the buttock lifting mechanism performs a lifting operation.

In the fourth aspect, the pelvis is twisted in a state in which the hip is held (movement is restricted). Thus, the twisting is further effective.

In a fifth aspect, the at least two lifting mechanisms include the hip lifting mechanism and the buttock lifting mechanism, and the hip lifting mechanism and the buttock lifting mechanism perform the stretching by carrying out a twisting operation on a pelvis of the user that combines a right twisting operation in which the right portion of the buttock lifting mechanism performs a lifting operation while, after a predetermined time, the left portion and the right portion of the hip lifting mechanism perform a lifting operation, and a left twisting operation in which the left portion of the buttock lifting mechanism performs a lifting operation while, after a predetermined time, the left portion and the right portion of the hip lifting mechanism perform a lifting operation.

In the fifth aspect, the pelvis is twisted in a state in which the hip is held (forward displacement and lateral movement or the like is restricted) during the twisting operation. Thus, the twisting is further effective.

In a sixth aspect, the at least two lifting mechanisms include the hip lifting mechanism and the buttock lifting mechanism, and the hip lifting mechanism and the buttock lifting mechanism perform the stretching by carrying out a twisting operation on a pelvis of the user that combines a right twisting operation in which the right portion of the buttock lifting mechanism performs a lifting operation while, after a predetermined time, the left portion and the right portion of the hip lifting mechanism perform a lifting operation, and, after a further predetermined time, the hip lifting mechanism is returned to a state prior to the lifting while maintaining the lifting operation performed by the buttock lifting mechanism, and a left twisting operation in which the left portion of the buttock lifting mechanism performs a lifting operation, after a predetermined time, the left portion and the right portion of the hip lifting mechanism perform a lifting operation, and, after a further predetermined time, the hip lifting mechanism is returned to a state prior to the lifting while maintaining the lifting operation performed by the buttock lifting mechanism.

In the sixth aspect, the pelvis is twisted in a state in which the hip is held (forward displacement and lateral movement or the like is restricted) during the twisting operation. Thus, the twisting is further effective. Further, the hip is released during the operation. This twists the hip in addition to the pelvis such that partial twisting changes to entire twisting. This produces a change in the twisting sensation, and the twisting operation avoids partial concentration.

In a seventh aspect, the at least two lifting mechanisms include the hip lifting mechanism and the buttock lifting mechanism, and the hip lifting mechanism and the buttock lifting mechanism perform the stretching by carrying out an backward arching operation on a pelvis of the user in which the left portion and the right portion of the hip lifting mechanism and the left portion and the right portion of the buttock lifting mechanism perform a lifting operation and, after a predetermined time, the buttock lifting mechanism is returned to a state prior to the lifting while maintaining the lifting operation performed by the hip lifting mechanism.

In the seventh aspect, from a state in which the pelvis is lifted, the lower portion of the pelvis is moved downward. This increases the downward movement and improves the backward arching sensation of the hip.

In an eighth aspect, the at least two lifting mechanisms include the hip lifting mechanism and the buttock lifting mechanism, and the hip lifting mechanism and the buttock lifting mechanism perform stretching by carrying out a forward tilting/rearward tilting operation on a pelvis of the user in which a lifting operation performed by the left portion and right portion of one of the lifting mechanisms among the hip lifting mechanism and the buttock lifting mechanism and a lifting operation performed by the left portion and right portion of the other one of the lifting mechanisms are alternately performed with a time lag in between.

In the eighth aspect, the tilting range of the forward tilting and rearward tilting of the pelvis is enlarged. Thus, the stretching sensation is improved when the pelvis is tilted forward and rearward.

A ninth aspect includes a leg fixing means for fixing a leg of the user. The hip lifting mechanism and the buttock lifting mechanism perform stretching in a state in which the leg fixing means fixes the leg of the user.

In the ninth aspect, the user's posture is restricted. Thus, the stretching of the pelvis and surrounding area with the hip and buttock lifting mechanism is further effective.

A tenth aspect includes an arm fixing means for fixing an arm of the user. The hip lifting mechanism and the buttock lifting mechanism perform stretching in a state in which the arm fixing means fixes the arm of the user.

In the tenth aspect, the posture of the user is restricted. Thus, the stretching of the pelvis and surrounding area with the hip and buttock lifting mechanism is further effective.

An eleventh aspect includes a massaging mechanism that performs a massaging operation with a massager on the back of the user. The hip lifting mechanism and the buttock lifting mechanism perform stretching at the same time as when the massaging mechanism performs the massaging operation.

In the eleventh embodiment, massaging and stretching may be performed on the user within a short period of time.

A twelfth aspect includes a thigh kneading means for kneading a thigh of the user from an outer side. The hip lifting mechanism and the buttock lifting mechanism perform stretching when the thigh kneading means performs the kneading operation.

In the twelfth aspect, the user's posture is restricted. Thus, the twisting of the pelvis is further effective.

In a thirteenth aspect, the backrest is reclinable, and the hip and buttock lifting mechanisms perform stretching in a state in which the backrest is reclined within 45° from a horizontal plane.

In the thirteenth aspect, the user is in a state close to lying down with his or her head faced upward.

A fourteenth aspect includes a vertically pivotal footrest arranged on a front end of the seat. The hip lifting mechanism and the buttock lifting mechanism perform stretching in a state in which the footrest is pivoted downward from a horizontal plane.

In the fourteenth aspect, the user's legs are bent downward. Thus, various types of stretching performed on the pelvis and surrounding area is further effective.

In a fifteenth aspect, the stretching includes a lifting operation performed by the front buttock lifting mechanism and carries out a twisting operation on a pelvis of the user by combining a right twisting operation in which the front buttock lifting mechanism performs a lifting operation while, after a predetermined time, the right portion of at least one of the hip lifting mechanism and the buttock lifting mechanism performs a lifting operation, and a left twisting operation in which the front buttock lifting mechanism performs a lifting operation while, after a predetermined time, the left portion of at least one of the hip lifting mechanism and the buttock lifting mechanism performs a lifting mechanism.

In the fifteenth aspect, the twisting operation is performed on the pelvis while lifting the front of the user's buttocks to prevent forward displacement of the user. Thus, the twisting is further effective.

In a sixteenth aspect, the stretching includes a lifting operation performed by the front buttock lifting mechanism and carries out a frontward tilting/rearward tilting operation on a pelvis of the user by alternately performing a lifting operation with the front buttock lifting mechanism and a lifting operation with the left portion and right portion of at least one of the hip lifting mechanism and the buttock lifting mechanism with a time lag in between.

In the sixteenth aspect, the lifting of the font of the buttocks allows the user's pelvis to be effectively tilted toward the rear. Thus, by combining this with the hip or buttock lifting operation, the forward tilting and rearward tilting of the pelvis improves the stretching sensation. Further, the forward tilting and rearward tilting of the pelvis allows for various types of stretching to be performed.

In a seventeenth aspect, the at least two lifting mechanisms include the three mechanisms of the hip lifting mechanism, the buttock lifting mechanism, and the front buttock lifting mechanism. Further, the control means controls the three mechanisms of the hip lifting mechanism, the buttock lifting mechanism, and the front buttock lifting mechanism in cooperation with one another to stretch the user.

In the seventeenth aspect, the stretching sensation of the pelvis and surrounding area is further improved.

The present invention provides a massage machine that improves the stretching sensation of the pelvis and surrounding area.

### BRIEF DESCRIPTION OF THE DRAWINGS

FIG. 1 is a schematic side view showing a chair type massage machine according to one embodiment;

FIG. 2 is a schematic plan view showing the chair type massage machine of FIG. 1;

FIG. 3 is an explanatory diagram illustrating an backward arching operation;

FIG. 4 is an explanatory diagram illustrating a twisting (turning) operation;

FIG. 5 is an explanatory diagram illustrating a twisting (sideward bending) operation;

FIG. 6 is an explanatory diagram illustrating a forward tilting/rearward tilting operation;

FIG. 7 is an explanatory diagram showing a first modification of FIG. 4;

FIG. 8 is an explanatory diagram showing a second modification of FIG. 4;

FIG. 9 is an explanatory diagram illustrating a stretching operation in another example; and

FIG. 10 is an explanatory diagram illustrating a stretching operation in a further example.

### EMBODIMENTS OF THE INVENTION

One embodiment of the present invention will now be discussed with reference to the drawings.

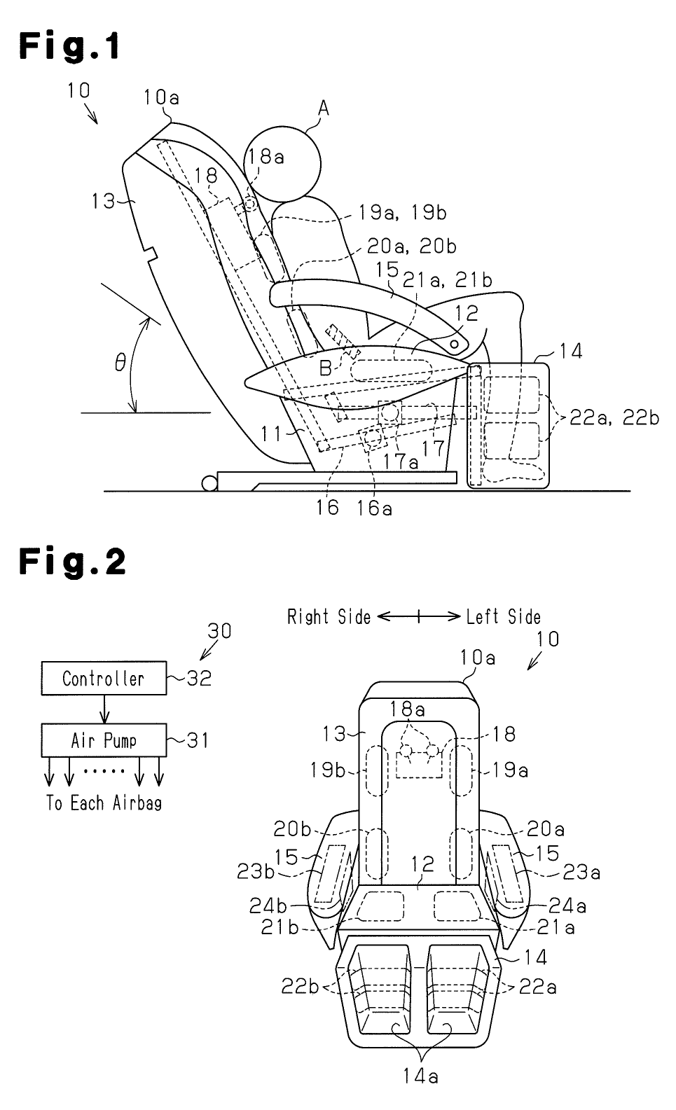

FIG. 1 shows a chair like massage machine according to the present embodiment. In the present specification, “left” and “right” respectively indicate the “left” and “right” as viewed from a user when seated on the chair type massage machine (refer to FIG. 2).

A chair body 10a of the chair type massage machine 10 includes a pair of left and right support legs 11, a seat 12 supported by the two support legs 11, and a reclinable backrest 13 adjacent to a rear end of the seat 12. The seat 12 has a front end to which a footrest 14 is coupled in a manner inclinable about a pivot shaft extending in a lateral direction. Armrests 15 are coupled to the two outer sides of the seat 12.

A reclining mechanism 16 for the backrest 13 is arranged under the seat 12. The reclining mechanism 16 includes a motor 16a, which is driven to allow for the inclination angle (reclining angle) of the backrest 13 to be varied. A vertical pivoting mechanism 17 for the footrest 14 is arranged under the seat 12. The vertical pivoting mechanism 17 includes a motor 17a, which is driven to vertically pivot the footrest 14.

A massaging mechanism 18 including massagers 18a are arranged in the backrest 13 at a middle part in the widthwise direction. The massaging mechanism 18 is movable in the vertical direction of the backrest 13 due to a motor (not shown). The massagers 18a are driven by a built-in motor (not shown) to perform a massaging operation that massages the back of a user A.

As shown in FIG. 2, a pair of left and right airbags 19a and 19b are incorporated in the two sides of an upper portion of the backrest 13. The pair of left and right airbags 19a and 19b are respectively associated with the left and right shoulders of the user A. A pair of left and right airbags 20a and 20b are incorporated in the two sides of a lower portion of the backrest 13. The pair of left and right airbags 20a and 20b are respectively associated with the left and right sides of the hip of the user A. A pair of left and right airbags 21a and 21b are incorporated in the seat 12. The pair of left and right airbags 21a and 21b are respectively associated with the left and right buttocks of the user A. The footrest 14 includes channel-shaped, left and right accommodation pockets 14a, which respectively accommodate the left and right legs of the user A. Airbags 22a and 22b are incorporated in the inner wall of the left and right accommodation pockets 14a. In this manner, the airbags 19a, 19b, 20a, 20b, 21a, 21b, 22a, and 22b are arranged in association with their massaging portions. The airbags 19a, 19b, 20a, 20b, 21a, 21b, 22a, and 22b are each connected by a connection hose (not shown) to a drive device 30. The drive device 30 is arranged, for example, between the support legs 11 under the seat 12. The drive device 30 includes an air pump 31, electromagnetic valves (not shown), which are respectively arranged in correspondence with the airbags 19a and 19b to 22a and 22b, and a controller 32, which controls the air pump 31 and the electromagnetic valves. In the drive device 30, the controller 32 controls and operates the air pump 31 and the electromagnetic valves so that each of the airbags 19a, 19b, 20a, 20b, 21a, 21b, 22a, and 22b are independently inflated and deflated.

Various types of operation modes are set for the controller 32. In accordance with the operation mode, the massaging mechanism 18 and the airbags 19a and 19b to 22a and 22b perform various types of massaging and stretching by operating along or in cooperation with one another. The operation modes include a pelvis mode, in which the hip airbags 20a and 20b cooperate with the buttock airbags 21a and 21b to effectively stretch mainly the pelvis B and surrounding muscle. Modes for performing “backward arching”, “twisting (turning)”, “twisting (sideward bending)”, and “forward tilting/rearward tilting” are set for the pelvis mode.

### [Backward Arching] Mode

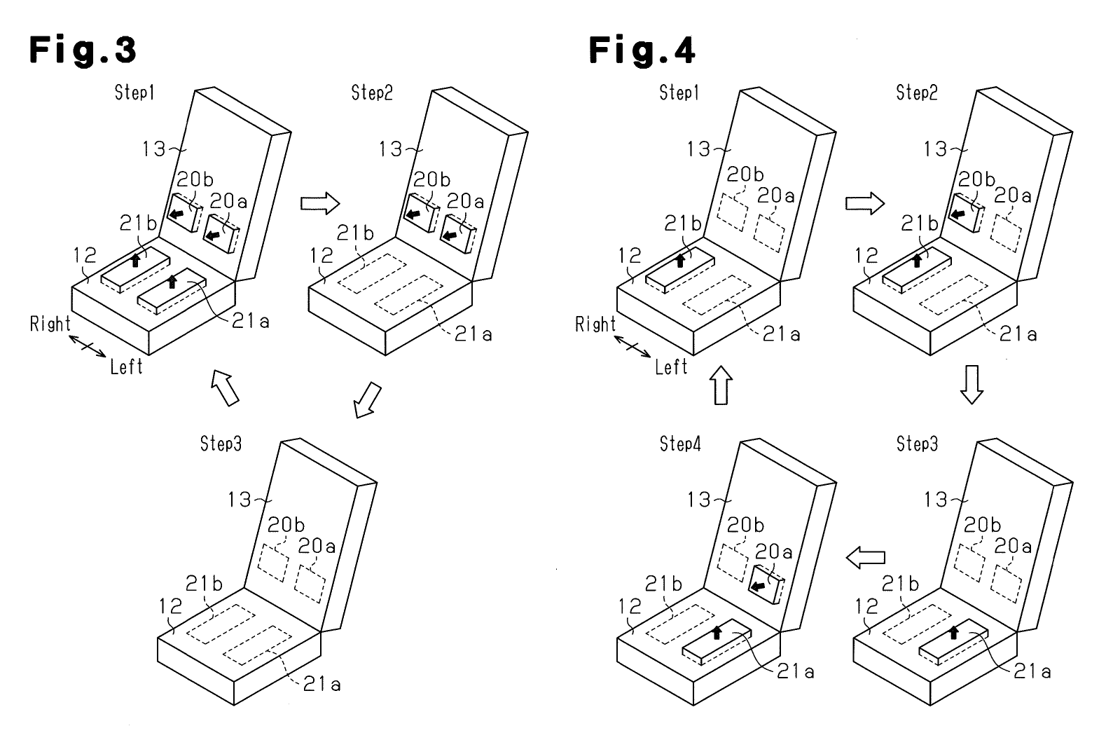

In step 1 of FIG. 3, the controller 32 simultaneously inflates all of the left and right hip airbags 20a and 20b and left and right buttock airbags 21a and 21b and maintains the inflated state for about ten to thirty seconds. Then, in step 2, while maintaining the inflated state of the left and right hip airbags 20a and 20b, the controller 32 simultaneously deflates the left and right airbags 21a and 21b and maintains the inflated state of the left and right hip airbags 20a and 20b for about ten to thirty seconds. Next, in step S3, the controller 32 simultaneously deflates the left and right hip airbags 20a and 20b and maintains the deflated state of the airbags 20a, 20b, 21a, and 21b for about ten to twenty seconds. The controller 32 then returns to step 1 and repeats the operations from step 1 to step 3 for a predetermined number of times.

First, the operation of step 1 in FIG. 3 lifts the buttocks and hip, or the pelvis B, of the seated user A. The operation of step 2 then downwardly moves the buttocks, or the lower portion of the pelvis B. In this manner, the stepped operation including the time lag between steps 1 and 2 greatly moves the lower portion of the pelvis B downward to improve the backward arching sensation of the hip. The amount lifted by these operations is set to be about five to twenty centimeters.

### [Twisting (Turning)] Mode

In step 1 of FIG. 4, the controller 32 inflates only the right buttock airbag 21b and maintains the inflated state for about five seconds. Then, in step 2, while maintaining the inflated state of the right buttock airbag 21b, the controller 32 inflates the right hip airbag 20b, which is located on the same side, and maintains the inflated state for about five to thirty seconds. Next, in step S3, the controller 32 simultaneously deflates the right buttock airbag 21b and the right hip airbag 20b. Then, the controller 32 inflates only the left buttock airbag 21a and maintains the inflated state for about five seconds. Next, in step 4, while maintaining the inflated state of the left buttock airbag 21a, the controller 32 inflates the left hip airbag 20a, which is located on the same side, and maintains the inflated state for about five to thirty seconds. Then, the controller 32 simultaneously deflates the left buttock airbag 21a and the left hip airbag 20a. The controller 32 returns to step 1 and repeats the operations from step 1 to step 4 for a predetermined number of times.

First, the operation of step 1 in FIG. 4 lifts the right buttock, or lower right side of the pelvis B, of the seated user A. The operation of step 2 then lifts the right side of the hip, which is the same side as the right buttock lifted in step 1, or the upper right side of the pelvis B. In this manner, the stepped operation including the time lag between step 1 and step 2 improves the twisting sensation of the right portion of the pelvis B. Further, the operation of step 3 lifts the left buttock, or lower left side of the pelvis B, of the seated user A. The operation of step 4 then lifts the left side of the hip, which is the same side, or the upper left side of the pelvis B. In this manner, the stepped operation including the time lag between steps 3 and 4 improves the twisting sensation of the right portion of the pelvis B. In other words, the repetition of steps 1 to 4 of FIG. 4 improves the twisting (turning) sensation of the pelvis B. The twisting angle in these operations may be set to be 10° to 30°.

In the “twisting (turning)” mode, the airbags 20a, 20b, 21a, and 21b may be set to be in a continuously deflated state for about five to twenty seconds between step 2 and step 3 and between step 4 and step 1 when switching from the right side to the left side and from the left side to the right side. Further, the buttock airbags 21a and 21b are inflated before inflating the hip airbags 20a and 20b. However, this may be reversed so that the hip airbags 20a and 20b are inflated before inflating the buttock airbags 21a and 21b. This would also improve the twisting (turning) sensation of the pelvis B.

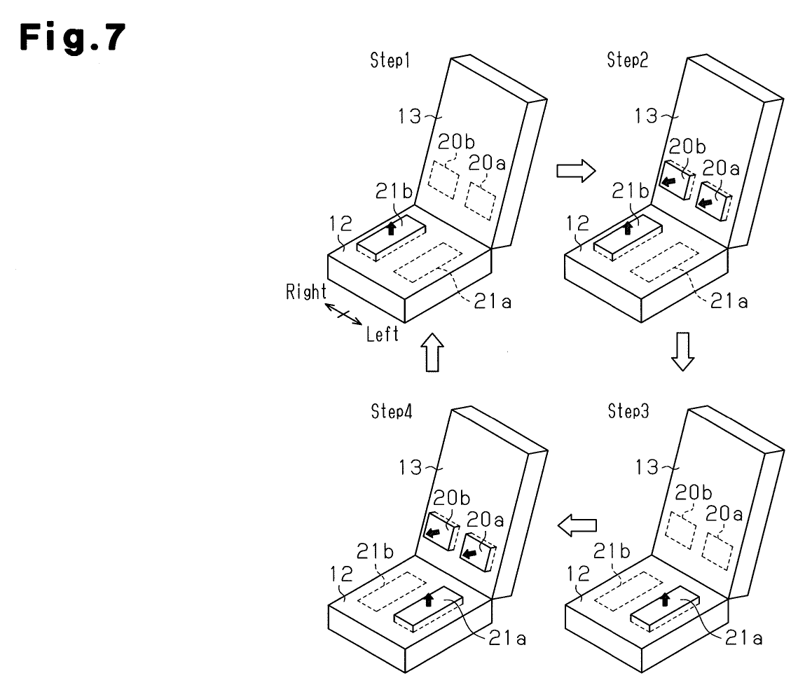

A modification of the above-described twisting operation will now be discussed with reference to FIG. 7. First, in step 1 of FIG. 7, the controller 32 inflates only the right buttock airbag 21b and continues the inflated state for a predetermined time. Then, in step 2, while maintaining the inflated state of the right buttock airbag 21b, the controller 32 inflates the left and right hip airbags 20a and 20b and continues the inflated state for a predetermined time. Next, in step 3, the controller 32 simultaneously deflates the inflated right buttock airbag 21b and left and right hip airbags 20a and 20b. Then, the controller 32 inflates only the left buttock airbag 21a and continues the inflated state for a predetermined time. Next, in step 4, while maintaining the inflated state of the left buttock airbag 21a, the controller 32 inflates the left and right hip airbags 20a and 20b and continues the inflated state for a predetermined time. Then, the controller 32 simultaneously deflates the left buttock airbag 21a and the left and right hip airbags 20a and 20b. Subsequently, the controller 32 returns to step 1 and repeats the operations of step 1 to step 4 for a predetermined number of times. The predetermined times are each set within a range of about five to thirty seconds.

The operations of step 1 and step 3 in FIG. 7 twists the pelvis B of the seated user A. When shifting from step 1 to step 2 and from step 3 to step 4 after a time lag, the pelvis B is twisted in a state in which the hip is held after the twisting starts (forward displacement and lateral movement of the hip and the like being restricted). Thus, the twisting (turning) is further effective.

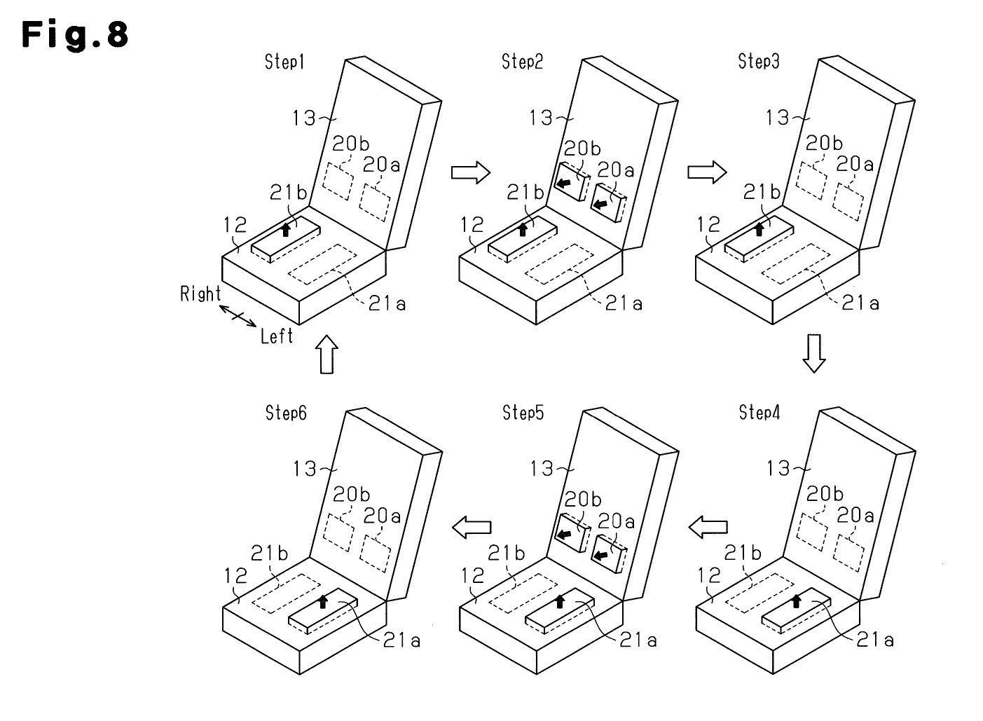

FIG. 8 shows a second modification of the above-discussed twisting operation. First, in step 1 of FIG. 8, the controller 32 inflates only the right buttock airbag 21b and continues the inflated state for a predetermined time. Then, in step 2, while maintaining the inflated state of the right buttock airbag 21b, the controller 32 inflates the left and right hip airbags 20a and 20b and continues the inflated state for a predetermined time. Next, in step 3, while maintaining the inflated state of the right buttock airbag 21b, the controller 32 deflates the left and right hip airbags 20a and 20b and continues the deflated state for a predetermined time. Next, in step 4, the controller 32 deflates the right buttock airbag 21b and then inflates the left buttock airbag 21a and continues the inflated state for a predetermined time. Then, in step 5, while maintaining the inflated state of the left buttock airbag 21a, the controller 32 inflates the left and right hip airbags 20a and 20b and continues the inflated state for a predetermined time. Next, in step 6, while maintaining the inflated state of the left buttock airbag 21a, the controller 32 deflates the left and right hip airbags 20a and 20b and continues the deflated state for a predetermined time. Then, the controller 32 deflates the left buttock airbag 21a and subsequently returns to step 1. The controller 32 repeats the operations of step 1 to step 6 for a predetermined number of times. The predetermined times are each set within a range of about five to thirty seconds.

The operations of step 1 and step 4 in FIG. 8 twists the pelvis B of the seated user A. When shifting from step 1 to step 2 and from step 4 to step 5 after a time lag, the pelvis B is twisted in a state in which the hip is held after the twisting starts (forward displacement and lateral movement of the hip and the like being restricted). Thus, the twisting (turning) is further effective. Further, when shifting from step 2 to step 3 and from step 5 to step 6, the hip is released during the twisting. In this state, in addition to the pelvis B, the hip is also twisted. This shifts from partial twisting to entire twisting and thereby produces a variation in twisting sensation. Further, the twisting operation avoids partial concentration.

### [Twisting (Sideward Bending)] Mode

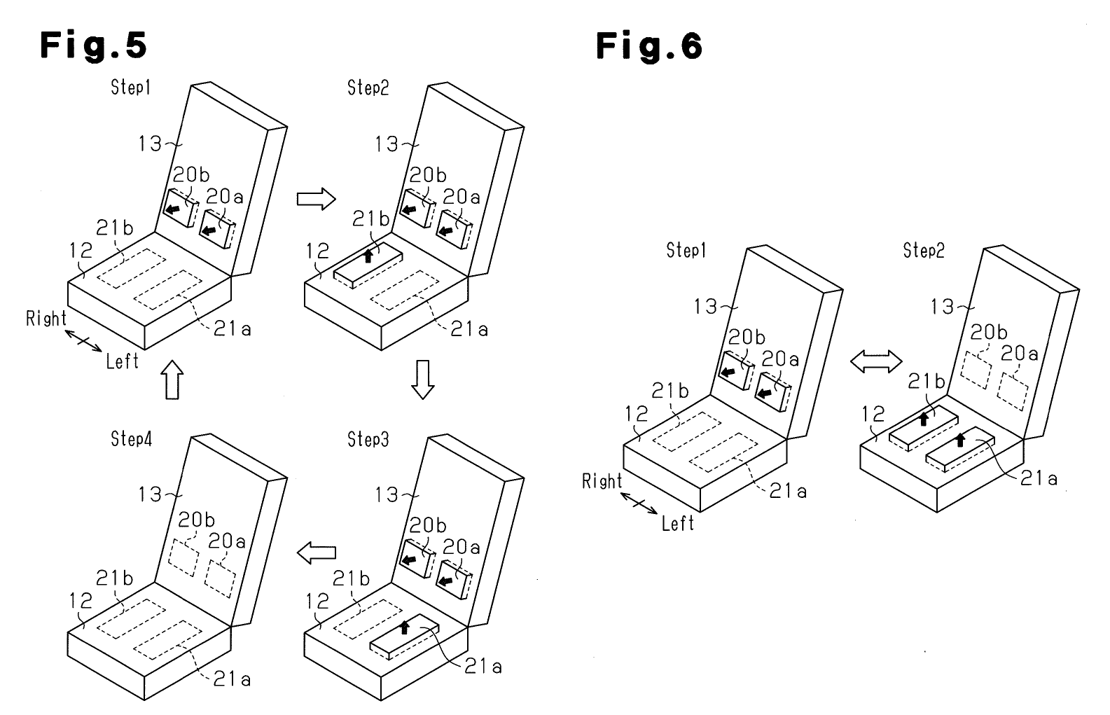

In step 1 of FIG. 5, the controller 32 simultaneously inflates the left and right hip airbags 20a and 20b and continues the inflated state for about five to ten seconds. Next, in step 2, while maintaining the inflated state of the left and right hip airbags 20a and 20b, the controller 32 inflates the right buttock airbag 21b and maintains the inflated state for about five to thirty seconds. Next, in step 3, after deflating the right buttock airbag 21b, the controller 32 inflates the left buttock airbag 21a and maintains the inflated state for about five to thirty seconds. Then, in step 4, the controller 32 simultaneously deflates the left buttock airbag 21a and left and right hip airbags 20a and 20b. The controller 32 returns to step 1 and repeats the operations of step 1 to step 4 for a predetermined number of times.

The operation of step 1 in FIG. 5 lifts both sides of the hip, that is, both sides of the upper portion of the pelvis B, of the seated user A. Then, the operation of step 2 lifts the right buttock, that is, the lower right side of the pelvis B. In this manner, the stepped movement including the time lag between step 1 and 2 lifts the lower right side of the pelvis B in a state in which the hip is held (movement is restricted). Thus, the twisting of the right portion of the pelvis B is further effective. Moreover, the operation of step 3 lifts the left buttock, that is, the lower left side of the pelvis B in a state in which both sides of the hip, that is, both sides of the upper portion of the pelvis B, is lifted. This lifts the lower left side of the pelvis B in a state in which the hip is held (movement is restricted). In this manner, the repetition of steps 1 to 4 improves the twisting (sideward bending) sensation of the pelvis B. The twisting angle in these operations may be set to be 10° to 30°.

### [Forward Tilting/Rearward Tilting] Mode

In step 1 of FIG. 6, the controller 32 simultaneously inflates the left and right hip airbags 20a and 20b and continues the inflated state for about ten to thirty seconds. Next, in step 2, the controller 32 simultaneously deflates the left and right hip airbags 20a and 20b, then simultaneously inflates the left and right airbags 21a and 21b, and maintains the inflated state for about ten to thirty seconds. The controller 32 returns to step 1 and repeats the operations of step 1 and step 2 for a predetermined number of times.

The operation of step 1 in FIG. 6 lifts both sides of the hip, that is, both sides of the upper portion of the pelvis B, of the seated user A. Then, the operation of step 2 lifts both buttocks, that is, both sides of the lower portion of the pelvis B, of the seated user A. In this manner, step 1 and step 2 are alternately repeated with a time lag in between. This enlarges the tilting range for the forward tilting and rearward tilting of the pelvis B and improves the stretching sensation resulting from the forward tilting and rearward tilting of the pelvis B.

The characteristic advantages of the present embodiment will now be described.

(1) In the present embodiment, the backrest 13 includes the left and right airbags 20a and 20b, which serve as a hip lifting mechanism, and the seat 12 includes the left and right airbags 21a and 21b, which serve as a buttock lifting mechanism. The hip airbags 20a and 20b and the buttock airbags 21a and 21b are controlled to operate in cooperation with one another using time lags so as to perform stretching of the pelvis B and surrounding muscle, such as backward arching, twisting (turning, sideward bending), and forward tilting/rearward tilting. That is, the hip airbags 20a and 20b act on the upper portion of the pelvis B, the buttock airbags 21a and 21b act on the lower potion of the pelvis B, and the airbags operation in cooperation with one another using time lags to improve various types of stretching sensations.

(2) In the present embodiment, the hip lifting mechanism and the buttock lifting mechanism are formed by the airbags 20a, 20b, 21a, and 21b, which are inflated and deflated. Other portions are also formed by the airbags 19a, 19b, 22a, and 22b. Thus, the massage machine 10 has a relatively simple structure, and the lifting (pressing) operation is smoothly performed.

The above embodiment of the present invention may be modified as described below.

There is no mention above on the posture of the user A when performing various types of stretches on the pelvis B and surrounding muscle. The stretching may be performed in a state in which the user A has his or her legs fixed by the airbags 22a and 22b, which serve as a leg fixing means of the footrest 14. In this case, the posture of the user A is restricted. Thus, the stretching is further effective.

In addition to fixing the legs, the user's arms may also be fixed. For example, as shown in FIG. 1, when the massage machine includes arm kneading devices 23a and 23b, which hold the user's arms with airbags or the like, in the left and right armrests 15, the stretching may be performed in a state in which the arms of the user A are fixed using the arm kneading devices 23a and 23b. This also restricts the posture of the user A. Thus, the stretching is further effective.

Further, for example, as shown in FIG. 1, when the massage machine includes left and right thigh kneading devices 24a and 24b, which serve as a thigh kneading means for kneading the thighs of the user A from the outer side toward the inner side, the kneading devices 24a and 24b may knead the thighs from the outer side. At the same time, stretching, namely, twisting of the pelvis B may also be twisted. This also restricts the posture of the user A. Thus, the stretching is further effective.

The stretching described above may be performed when massaging the user's back with the massagers 18a of the massaging mechanism 18. This would allow for massaging and stretching to be performed on the user A within a short period of time.

The stretching described above may be performed with the reclining angle θ (refer to FIG. 2) of the backrest 13 being 45° or less. This would result in the user A being in a state close to lying down with his or her head facing upward. Thus, the stretching is further effective.

Although the pivot position of the footrest 14 has not been mentioned in particular, as shown in FIG. 1, it is preferable that the stretching described above be performed in a state in which the footrest 14 is pivoted to a state that is lower than a horizontal plane. This would bend the legs of the user A downward. Thus, the stretching is further effective.

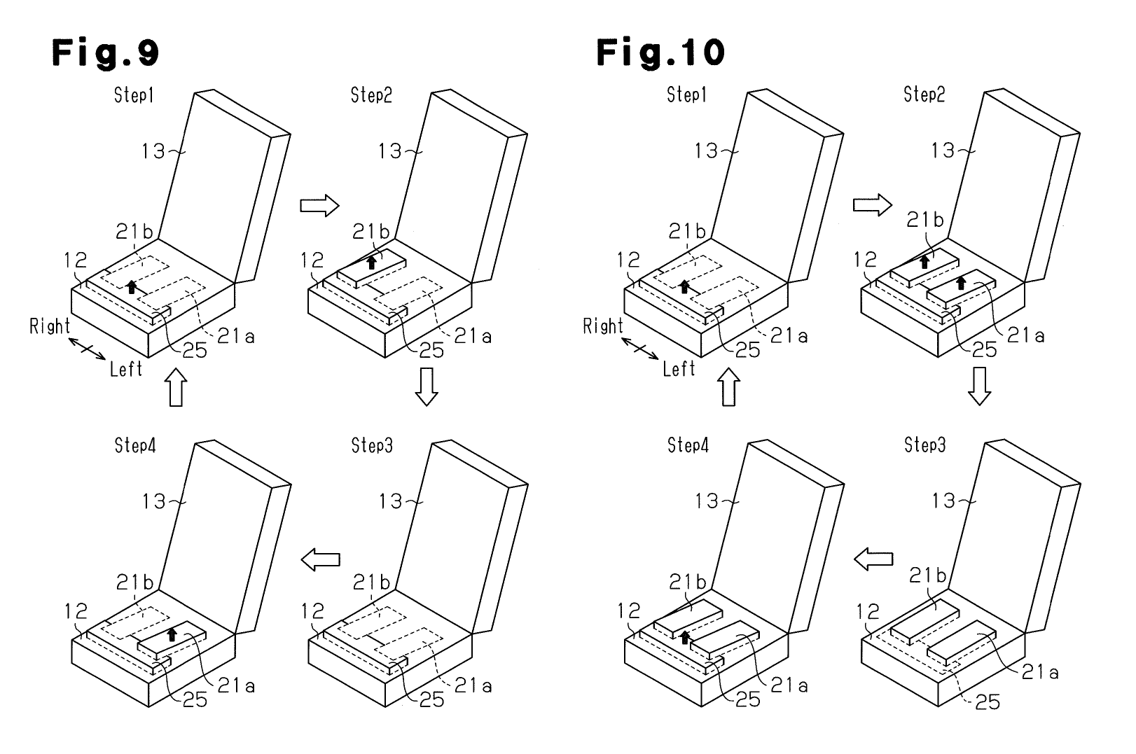

The massage machine 10 shown in FIGS. 9 and 10 include a front buttock airbag (buttock frontward lifting mechanism) 25, which extends toward the left and right near the front end (referred to as a front portion) of the seat 12. The front buttock airbag 25 is arranged so as to be overlapped with the front lower side of the left and right buttock airbags 21a and 21b. In addition to the front buttock airbag 25, the hip airbags 20a and 20b and the buttock airbags 21a and 21b are combined as required and operated in cooperation with one another. This allows for the stretching sensation of the pelvis B and surrounding muscle to be further improved.

For example, in step 1 of FIG. 9, the controller 32 inflates the front buttock airbag 25. During the inflation in step 1 or after the inflation in step 2, the controller 32 inflates the right buttock airbag 21b and continues the inflated state for a predetermined time. Next, in step 3, while maintaining the inflated state of the front buttock airbag 25, the controller 32 deflates the right buttock airbag 21b. In step 4, the controller 32 inflates the left buttock airbag 21a and continues the inflated state for a predetermined time. Then, the controller 32 simultaneously deflates the left buttock airbag 21a and the front buttock airbag 25. The controller 32 returns to step 1 and repeats the operations from step 1 to step 4 for a predetermined number of times. The predetermined times are each set within a range of about five to thirty seconds.

The operation of step 1 in FIG. 9 lifts the front of the buttocks (including the thighs) of the seated user A and prevents the user from being displaced toward the front. In such a state in which forward displacement is prevented, the pelvis B is twisted in subsequent step 2 and step 4. Thus, the twisting (sideward bending) is further effective.

Another example will be described with reference to FIG. 10. In step 1 of FIG. 10, the controller 32 inflates the front buttock airbag 25 and continues the inflated state for a predetermined time. Then, in step 2, while maintaining the inflated state of the front buttock airbag 25, the controller 32 inflates the left and right buttock airbags 21a and 21b and continues the inflated state for a predetermined time. Next, in step 3, while maintaining the inflated state of the left and right buttock airbags 21a and 21b, the controller 32 deflates the front buttock airbag 25 and continues this state for a predetermined time. Next, in step 4, while maintaining the inflated state of the left and right airbags 21a and 21b, the controller 32 inflates the front buttock airbag 25 and maintains the inflated state for a predetermined time. Then, the controller 32 deflates the left and right buttock airbags 21a and 21b and proceeds to step 1. The controller 32 repeats the operations from step 1 to step 4 for a predetermined number of times. That is, the lifting operation of the front buttock airbag 25 and the lifting operation of the left and right buttock airbags 21a and 21b are alternately performed with a time lag in between. The predetermined times are each set within a range of about five to thirty seconds.

In the example of FIG. 10, the lifting operation of the front of the buttocks effectively tilts the pelvis B of the seated user A toward the rear. Thus, in combination with the buttock lifting operation, the stretching sensation resulting from the forward tilting and rearward tilting of the pelvis B is further improved. This also allows for a variety of stretches when tilting the pelvis B toward the front and the rear.

In the examples of FIGS. 9 and 10, instead of the left and right buttock airbags 21a and 21b, the left and right hip airbags 20a and 20b may be deflated. Further, the hip and buttock airbags 20a, 20b, 21a, and 21b may be inflated in combination when necessary.

A mechanism for lifting (pushing) different parts of the user may be formed by the airbags 19a and 19b to 21a and 22b and 25. Further, the devices 23a, 23b, 24a, and 24b are formed from airbags or the like but are not limited in such a manner and may be formed by electric expansion/contraction mechanism or electric oscillating mechanisms.

1. A chair-type massage machine including a backrest and a seat, the massage machine comprising:
at least two lifting mechanisms from among a hip lifting mechanism, which is arranged on the backrest and includes a left portion and right portion, a buttock lifting mechanism, which is arranged on the seat and includes a left portion and a right portion, and a front buttock lifting mechanism, which is arranged on a front part of the seat and extends in a widthwise direction; and
a control means for controlling the at least two lifting mechanisms, wherein the control means operates the at least two lifting mechanisms in cooperation with one another with a time lag in between to perform stretching on a user.

2. The massage machine according to claim 1, wherein the at least two lifting mechanisms include the hip lifting mechanism and the buttock lifting mechanism, and the hip lifting mechanism and the buttock lifting mechanism perform the stretching by carrying out a twisting operation on a pelvis of the user that combines:
a right twisting operation in which one of the right portions of the hip lifting mechanism and the buttock lifting mechanism performs a lifting operation and, after a predetermined time, the other one of the right portions performs a lifting operation; and
a left twisting operation in which one of the left portions of the hip lifting mechanism and the buttock lifting mechanism performs a lifting operation and, after a predetermined time, the other one of the left portions performs a lifting operation.

3. The massage machine according to claim 2, wherein each of the lifting mechanisms is formed by an airbag that is inflated and deflated.

4. The massage machine according to claim 1, wherein the at least two lifting mechanisms include the hip lifting mechanism and the buttock lifting mechanism, and the hip lifting mechanism and the buttock lifting mechanism perform the stretching by carrying out a twisting operation on a pelvis of the user that combines:
a right twisting operation in which the left portion and the right portion of the hip lifting mechanism perform a lifting operation while, after a predetermined time, the right portion of the buttock lifting mechanism performs a lifting operation; and
a left twisting operation in which the left portion of the buttock lifting mechanism performs a lifting operation.

5. The massage machine according to claim 1, wherein the at least two lifting mechanisms include the hip lifting mechanism and the buttock lifting mechanism, and the hip lifting mechanism and the buttock lifting mechanism perform the stretching by carrying out a twisting operation on a pelvis of the user that combines:
a right twisting operation in which the right portion of the buttock lifting mechanism performs a lifting operation while, after a predetermined time, the left portion and the right portion of the hip lifting mechanism perform a lifting operation; and
a left twisting operation in which the left portion of the buttock lifting mechanism performs a lifting operation while, after a predetermined time, the left portion and the right portion of the hip lifting mechanism perform a lifting operation.

6. The massage machine according to claim 1, wherein the at least two lifting mechanisms include the hip lifting mechanism and the buttock lifting mechanism, and the hip lifting mechanism and the buttock lifting mechanism perform the stretching by carrying out a twisting operation on a pelvis of the user that combines:
a right twisting operation in which the right portion of the buttock lifting mechanism performs a lifting operation while, after a predetermined time, the left portion and the right portion of the hip lifting mechanism perform a lifting operation, and, after a further predetermined time, the hip lifting mechanism is returned to a state prior to the lifting while maintaining the lifting operation performed by the buttock lifting mechanism; and
a left twisting operation in which the left portion of the buttock lifting mechanism performs a lifting operation, after a predetermined time, the left portion and the right portion of the hip lifting mechanism perform a lifting operation, and, after a further predetermined time, the hip lifting mechanism is returned to a state prior to the lifting while maintaining the lifting operation performed by the buttock lifting mechanism.

7. The massage machine according to claim 1, wherein the at least two lifting mechanisms include the hip lifting mechanism and the buttock lifting mechanism; and
the hip lifting mechanism and the buttock lifting mechanism perform the stretching by carrying out an backward arching operation on a pelvis of the user in which the left portion and the right portion of the hip lifting mechanism and the left portion and the right portion of the buttock lifting mechanism perform a lifting operation and, after a predetermined time, the buttock lifting mechanism is returned to a state prior to the lifting while maintaining the lifting operation performed by the hip lifting mechanism.

8. The massage machine according to claim 1, wherein the at least two lifting mechanisms include the hip lifting mechanism and the buttock lifting mechanism; and
the hip lifting mechanism and the buttock lifting mechanism perform stretching by carrying out a forward tilting/rearward tilting operation on a pelvis of the user in which a lifting operation performed by the left portion and right portion of one of the lifting mechanisms among the hip lifting mechanism and the buttock lifting mechanism and a lifting operation performed by the left portion and right portion of the other one of the lifting mechanisms are alternately performed with a time lag in between.

9. The massage machine according to claim 1, further comprising:
a leg fixing means for fixing a leg of the user, wherein the hip lifting mechanism and the buttock lifting mechanism perform stretching in a state in which the leg fixing means fixes the leg of the user.

10. The massage machine according to claim 1, further comprising:
an arm fixing means for fixing an arm of the user, wherein the hip lifting mechanism and the buttock lifting mechanism perform stretching in a state in which the arm fixing means fixes the arm of the user.

11. The massage machine according claim 1, further comprising:
a massaging mechanism that performs a massaging operation with a massager on the back of the user, wherein the hip lifting mechanism and the buttock lifting mechanism perform stretching at the same time as when the massaging mechanism performs the massaging operation.

12. The massage machine according to claim 3, further comprising:
a thigh kneading means for kneading a thigh of the user from an outer side, wherein the hip lifting mechanism and the buttock lifting mechanism perform stretching when the thigh kneading means performs the kneading operation.

13. The massage machine according to claim 1, wherein the backrest is reclinable, and the hip and buttock lifting mechanisms perform stretching in a state in which the backrest is reclined within 45° from a horizontal plane.

14. The massage machine according to claim 1, further comprising:
a vertically pivotal footrest arranged on a front end of the seat, wherein the hip lifting mechanism and the buttock lifting mechanism perform stretching in a state in which the footrest is pivoted downward from a horizontal plane.

15. The massage machine according to claim 1, wherein the stretching includes a lifting operation performed by the front buttock lifting mechanism and carries out a twisting operation on a pelvis of the user by combining:
a right twisting operation in which the front buttock lifting mechanism performs a lifting operation while, after a predetermined time, the right portion of at least one of the hip lifting mechanism and the buttock lifting mechanism performs a lifting operation; and
a left twisting operation in which the front buttock lifting mechanism performs a lifting operation while, after a predetermined time, the left portion of at least one of the hip lifting mechanism and the buttock lifting mechanism performs a lifting mechanism.

16. The massage machine according to claim 1, wherein the stretching includes a lifting operation performed by the front buttock lifting mechanism and carries out a frontward tilting/rearward tilting operation on a pelvis of the user by alternately performing a lifting operation with the front buttock lifting mechanism and a lifting operation with the left portion and right portion of at least one of the hip lifting mechanism and the buttock lifting mechanism with a time lag in between.

17. The massage machine according to claim 1, wherein the at least two lifting mechanisms include the three mechanisms of the hip lifting mechanism, the buttock lifting mechanism, and the front buttock lifting mechanism; and
the control means controls the three mechanisms of the hip lifting mechanism, the buttock lifting mechanism, and the front buttock lifting mechanism in cooperation with one another to stretch the user.
